(19) United States
(12) Patent Application Publication
(10) Pub. No.: US 2025/0061072 A1
(43) Pub. Date: Feb. 20, 2025

(54) HDMI display control

(71) Applicant: Wayne McDaniel, Ft. Myers, FL (US)

(72) Inventor: Wayne McDaniel, Ft. Myers, FL (US)

(21) Appl. No.: 18/451,169

(22) Filed: Aug. 17, 2023

(51) Int. Cl. G06F 13/24; G06F 13/40; H04N 21/4363

(52) U.S. Cl. CPC G06F 13/24; G06F 13/4081; H04N 21/43635

(57) ABSTRACT

The HDMI display controller allows a user to electrically disconnect an HDMI display from a source while leaving the associated cables in place. Disconnection is accomplished by routing electrical signals present in the wiring of the HDMI cable through one or more controller chips or switches. The user operates an external switch or button that disconnects or breaks an electrical signal that is passing along one or more wires.

### FIELD

This invention relates to the field of HDMI cabling and more particularly to a device for activating and deactivating an external display connected via an HDMI cable.

### BACKGROUND

HDMI (High-Definition Multimedia Interface) cables are commonly used to connect audio and video components in the home and office. This includes devices such as computer monitors, televisions, projectors, various external displays, streaming media players, and so forth.

An HDMI cable includes protocols that allow a source, such as a computer, to be notified when a display has been connected. Having a display automatically turn on, and potentially mirror the display of a user's computer, can create problems.

For example, when a laptop is used for presentation it may be helpful to disable the external display between presentations.

Or when the laptop is used to present discrete items, such as exhibits in a court case, disabling the external display while the user searches for the next exhibit results in a more organized presentation.

Currently, disabling the external display requires either disabling the display in a menu within the computer's operating system or physically unplugging the HDMI cable. Both methods are inefficient.

What is needed is a way for a user to disable an external HDMI display without physically unplugging the display from the source.

### SUMMARY

The HDMI display controller allows a user to electrically disconnect an HDMI display from a source while leaving the associated cables in place.

Disconnection is accomplished by routing electrical signals present in the wiring of the HDMI cable through one or more controller chips, modules, or switches. The user operates an external switch or button that disconnects or breaks an electrical signal that is passing along one or more wires or signal paths.

In a first embodiment of the invention, the switch disconnects all wires, simulating the HDMI cable being fully unplugged.

In a second embodiment of the invention, the switch disconnects only one wire. For example, the HPD, or hot plug detect. Disconnecting this wire simulates removal of the plug.

In the third embodiment of the invention, alternative collections of wires/signal lines are disconnected by the switch. For example, the data carried along the wires one through twelve, corresponding with pins one through twelve, which carry video and audio data. In this embodiment, when the switch is actuated, the source would still believe the display to be connected, but the display would not receive video information and therefore would have no data to display.

Restated, an apparatus is disclosed for selectively blocking signals transmitted through an HDMI cable. The apparatus comprises an input HDMI connector and an output HDMI connector with one or more signal conducting paths connecting them. One or more signal blocking elements are positioned along the conducting paths. A control unit or module communicates with the blocking elements and to activate in response to an external trigger to selectively interrupt signals between the input and output connectors. The blocking elements may be mechanical or electronic switches. An optional power source provides electrical power to the control unit and blocking elements. The blocked signals may include all signals between the connectors, only the Hot Plug Detect signal on pin 19, or only the video signals on pins 1-12.

Also disclosed is a signal blocking device for connecting between an HDMI source and display. The device comprises a housing with an input HDMI port and an output HDMI port. A signal blocking controller is positioned between the input and output ports. A user-operated switch causes the controller to interrupt signal paths between the ports, thereby blocking video signals.

Additionally disclosed is an apparatus for controlling signal transmission between an input and output. It comprises a switch with input and output connections, each having up to nineteen signal paths. The switch has two states-a closed state connecting all paths between the connections, and an open state selectively disconnecting paths. In the open state, video signal transmission is interrupted.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a first view of a first embodiment of the HDMI display control.

FIG. 2 illustrates a first view of a second embodiment of the HDMI display control.

FIG. 3 illustrates a typical male HDMI connector.

FIG. 4 illustrates a table correlating HDMI pins with their function.

FIG. 5 illustrates a schematic view of a third embodiment of the HDMI display control.

FIG. 6 illustrates schematic view of a fourth embodiment of the HDMI display control.

FIG. 7 illustrates schematic view of a fifth embodiment of the HDMI display control.

FIG. 8 illustrates an interior view of the HDMI display control.

FIG. 9 illustrates a second interior view of the HDMI display control.

FIG. 10 illustrates a typical use of the HDMI display control.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

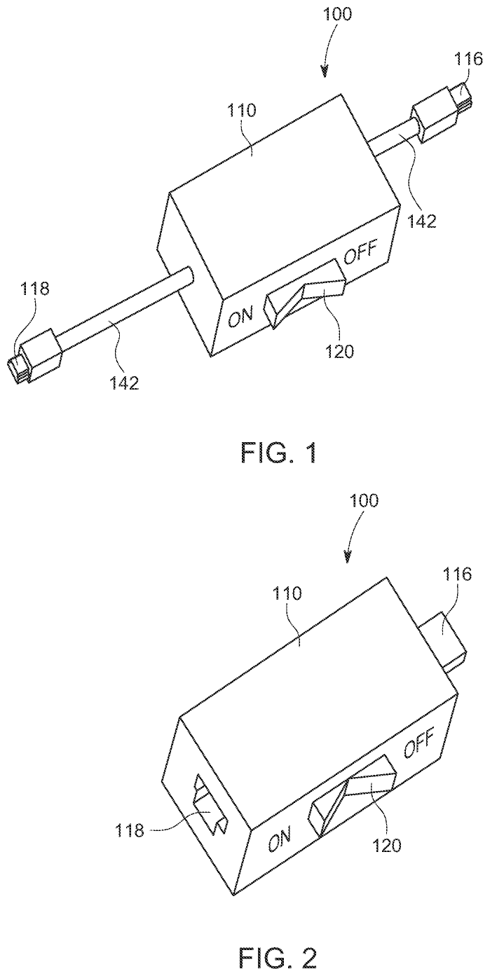

Referring to FIGS. 1 and 2, a first view of a first embodiment and the second embodiment of the HDMI display control is shown.

The HDMI display control 100 includes a housing 110 with housing upper half 112 and housing lower half 114. An input 116 connects to a source, such as the computer, and the output 118 connects to a display, such as a computer monitor.

The first embodiment of the HDMI display controller 100, shown in FIG. 1, includes cable 142 between the housing 110 and the input 116 and output 118. The second embodiment, shown in FIG. 2, omits the cable 142, instead of allowing the user to plug the device directly into a source, with the cabling remaining separate.

A switch 120 controls whether the device blocks or permits the HDMI signal to pass through.

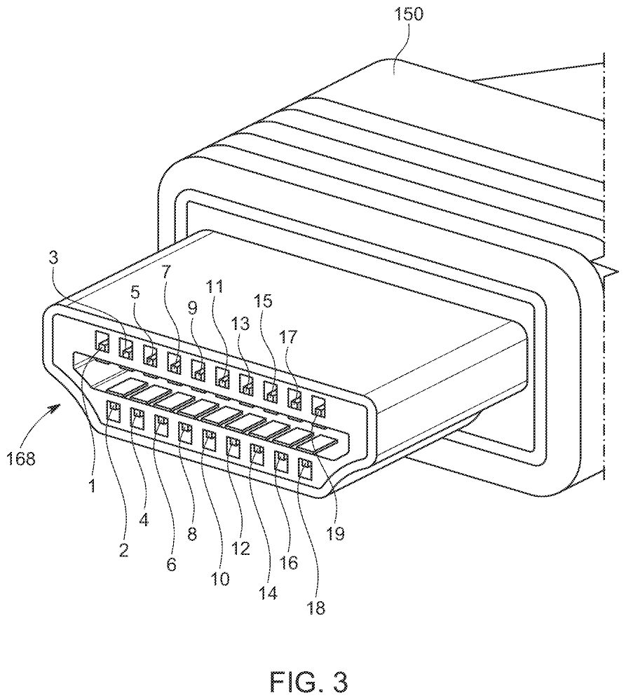

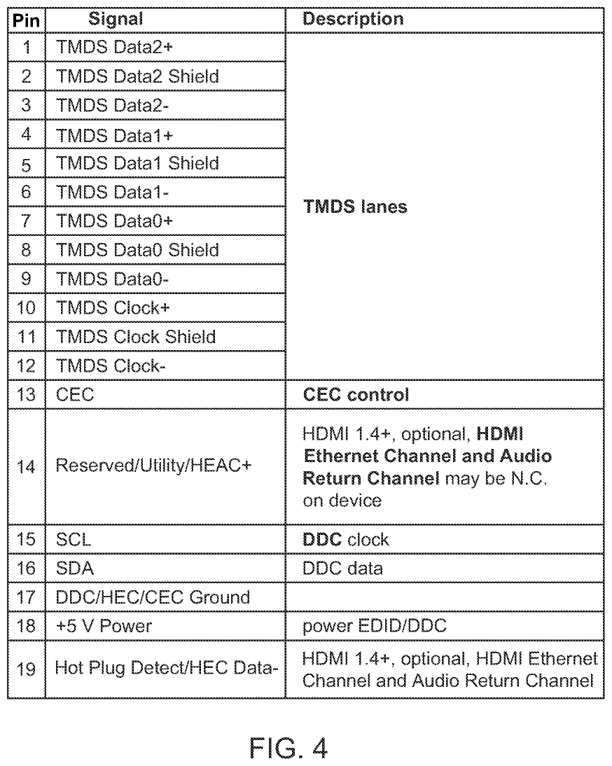

Referring to FIGS. 3 and 4, a typical male HDMI connector, a table correlating HDMI pins with their function of the HDMI display control, are shown.

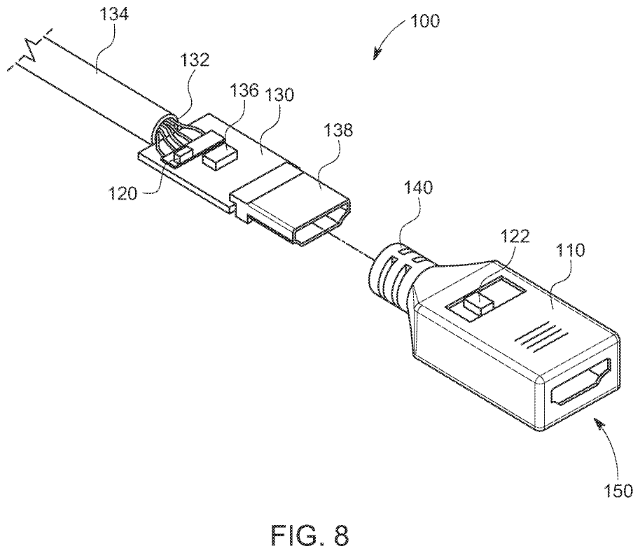

Each HDMI pin of a connecting head 150 carries particular information between the source 160 and the display 164 (see FIG. 8).

Pins 1 through 9 carry signal data encoded using transmission minimized differential signaling, or TMDS. This formatting minimizes interference.

Pins 10 through 12 carry a clock signal to synchronize the display with the source.

Pin 13 carries remote control signals, allowing a single remote to communicate with multiple devices.

Pin 14 is not used on all devices.

Pins 15 and 16 allow the display to communicate its identification to the source.

Pin 17 is electronic ground.

Pin 18 provides 5-volt power.

Pin 19 carries a signal indicating when an HDMI cable is plugged in, signaling to the source to initiate an electronic handshake to establish communication and negotiate display capabilities. This is sometimes referred to as the Hot Plug Detect (HPD) signal.

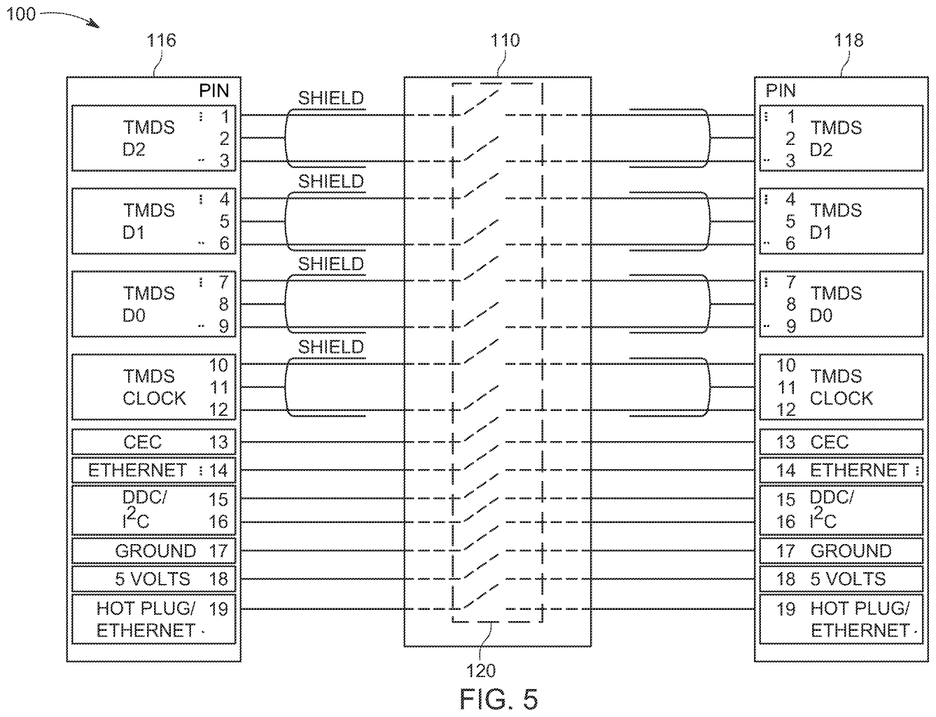

Referring to FIG. 5, a schematic View of third embodiment of the HDMI display control is shown.

In this embodiment, the switch 120 within the housing 110 disconnects all paths between the input 116 and the output 118. This effectively disconnects the input 116 from the output 118, indicating to the source 160 the display 164 (see FIG. 8) is no longer connected.

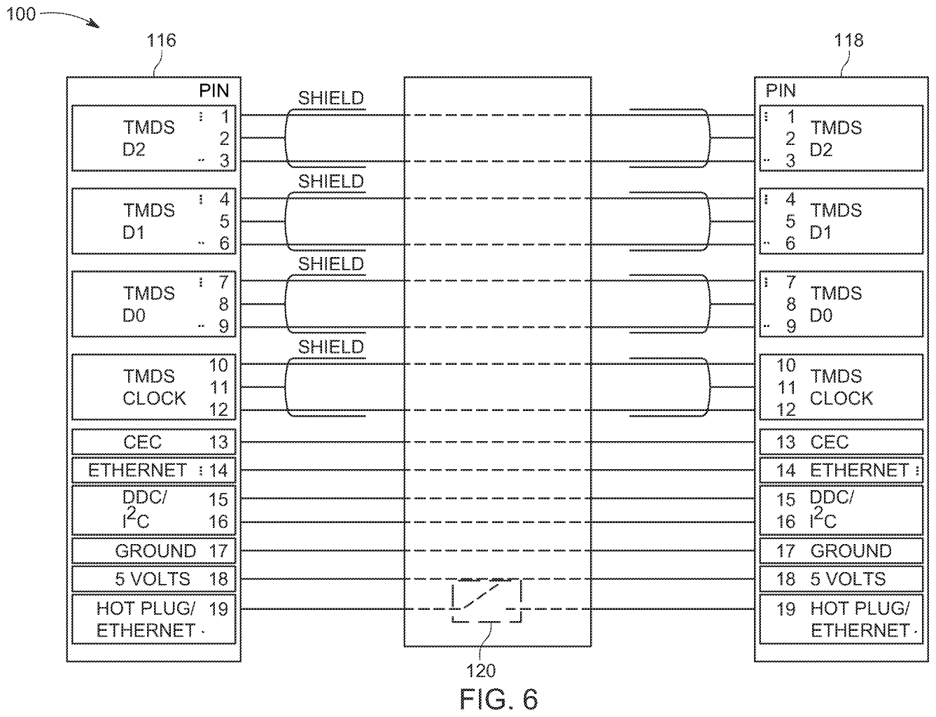

Referring to FIG. 6, schematic view of a fourth embodiment of the HDMI display control is shown.

In this embodiment, the switch 120 within the housing 110 disconnects only the path for pin 19 between the input 116 and the output 118. This disconnects the Hot Plug Detect path between the input 116 from the output 118, indicating to the source 160 that the display 164 (see FIG. 8) is no longer connected. This disconnect methodology may not work effectively for all sources 160 and displays 164, as compared to the alternative shown in FIG. 5, which is likely more universal.

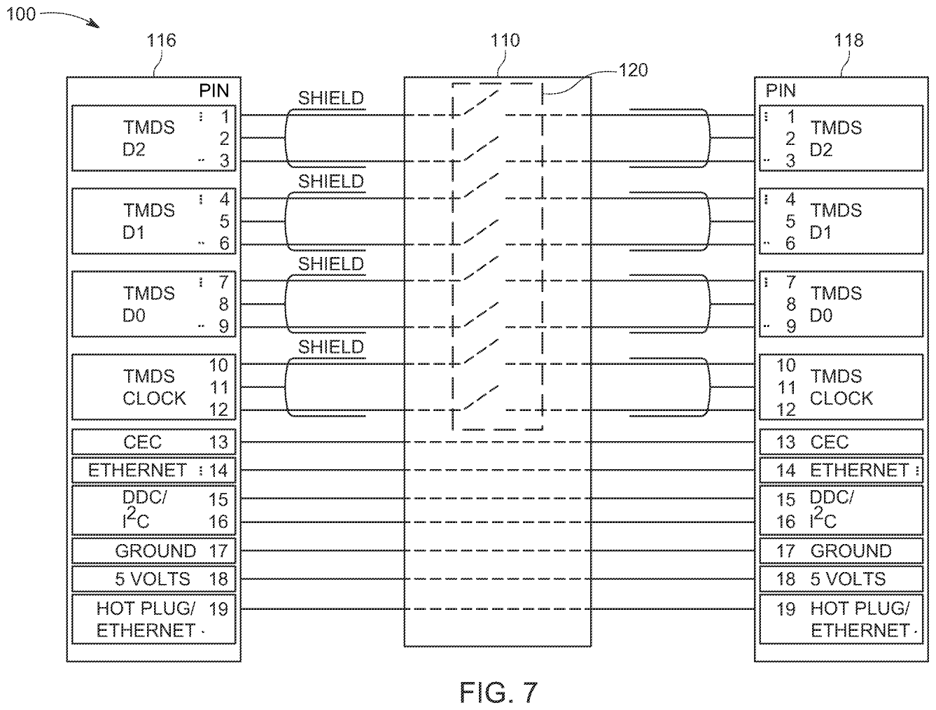

Referring to FIG. 7, schematic view of a fifth embodiment of the HDMI display control is shown.

In this embodiment, the switch 120 within the housing 110 disconnects only the paths for video signals—pins 1 through 12. By disconnecting these pins, the display no longer receives video from the source, but does not believe the display has been connected. This may decrease the time between actuation of the switch and reappearance of video on the display by preventing the synchronizing steps required when the source discovers a new display.

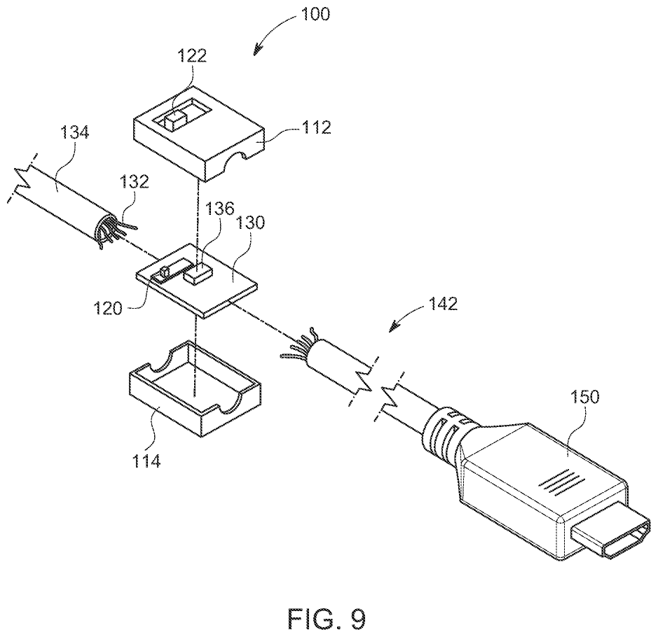

Referring to FIGS. 8 and 9, two interior views of the HDMI display control are shown.

The housing 110 encloses a circuit board 130 with control chip 136. Wires 132 carry signals to a switch 120 that is actuated from the outside of the housing 110 via switch cover 122. The wires 132 are enclosed in the sheath 134 to create a cable 142.

The HDMI display controller 100 can be integrated in two-way connecting head 150 as shown in FIG. 7, or in along the cable 142 between connecting heads as shown in FIG. 8. Or the HDMI display controller 100 can be manufactured without cabling, instead being a device that plugs in directly, as shown in FIG. 2.

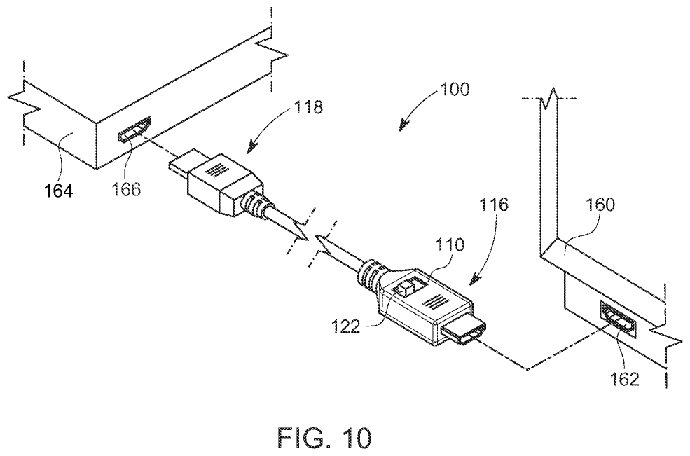

Referring to FIG. 10, a typical use of the HDMI display control is shown. The HDMI display controller 100 is placed between source 160 with source HDMI port 162 and display 164 with display HDMI port 166. Display signals are carried from the source 160 to the input 116, where the position of the switch cover 122, and internal switch 120 (see FIG. 8) determines whether and which signals pass through to the output 118.

Equivalent elements can be substituted for the ones set forth above such that they perform in substantially the same manner in substantially the same way for achieving substantially the same result.

What is claimed is:

1. A device for selectively interrupting signal transmission through an HDMI cable, the device comprising:
a first HDMI connector;
a second HDMI connector;
one or more signal lines passing from the first HDMI connector to the second HDMI connector;
one or more signal interrupters place along the one or more signal lines;
each signal interrupter of the one or more signal interrupters configured to interrupt transmission of a particular signal when actuated;
a control module communicating with the one or more signal interrupters;
the control module configured to actuate the one or more signal interrupters in response to an external input, thereby causing a selective interruption of one or more signals between the first HDMI connector and the second HDMI connector.

2. The device for selectively interrupting signal transmission through an HDMI cable of claim 1, wherein the one or more signal interrupters is a mechanical switch.

3. The device for selectively interrupting signal transmission through an HDMI cable of claim 1, wherein the one or more signal interrupters is an electronic switch.

4. The device for selectively interrupting signal transmission through an HDMI cable of claim 1, further comprising:
a power source for supplying electrical power to the control module and the one or more signal interrupters.

5. The device for selectively interrupting signal transmission through an HDMI cable of claim 1, wherein:
the particular signal interrupted by the one or more signal interrupters includes all signals between the first HDMI connector and the second HDMI connector.

6. The device for selectively interrupting signal transmission through an HDMI cable of claim 1, wherein:
the particular signal interrupted by the one or more signal interrupters includes only a Hot Plug Detect (HPD) signal carried by pin 19.

7. The device for selectively interrupting signal transmission through an HDMI cable of claim 1, wherein:
the particular signal interrupted by the one or more signal interrupters are video signals carried by pins 1 through 12.

8. A signal interruption device for connection between an HDMI signal source and an HDMI display, the signal interruption device comprising:
a housing;
an input HDMI connection disposed on the housing;
an output HDMI connection disposed on the housing;
a signal interruption controller disposed between the input HDMI connection and the output HDMI connection;
a switch for actuation by a user, the switch causing the signal interruption controller to break one or more signal paths between the input HDMI connection and the output HDMI connection;
whereby the signal interruption controller interrupts one or more signal paths, preventing transmission of video signals between the input HDMI connection and the output HDMI connection.

9. The signal interruption device of claim 8, wherein the signal interruption controller is a mechanical switch.

10. The signal interruption device of claim 8, wherein the signal interruption controller is an electronic switch.

11. The signal interruption device of claim 8, further comprising:
a power source for supplying electrical power to signal interruption controller.

12. The signal interruption device of claim 8, wherein:
the one or more signal paths interrupted by the signal interruption controller include all signals between the input HDMI connection and the output HDMI connection.

13. The signal interruption device of claim 8, wherein:
the one or more signal paths interrupted by the signal interruption controller includes only a Hot Plug Detect (HPD) signal carried by pin 19.

14. The signal interruption device of claim 8, wherein:
the one or more signal paths interrupted by the signal interruption controller include are video signals carried by pins 1 through 12.

15. A device to control transmittal of a signal between an input and an output, the device comprising:
a switch with a plurality of connections, the plurality of connections including:
a first connection to act as an input;
the first connection including up to nineteen signal paths;
a second connection to act as an output;
the second connection including up to nineteen signal paths;
the switch with the plurality of connections having a first state and a second state:
in the first state, the switch connects all signal paths between the first connection and the second connection;
in the second state, the switch selectively disconnects signal paths between the first connection and the second connection;
whereby when in the second state a transmission of a video signal between the input and the output is interrupted.

16. The device to control transmittal of a signal between an input and an output of claim 15, wherein the switch with a plurality of connections is a mechanical switch.

17. The device to control transmittal of a signal between an input and an output of claim 15, wherein the switch with a plurality of connections is an electronic switch.

18. The device to control transmittal of a signal between an input and an output of claim 15, wherein:
all nineteen signal paths are interrupted by actuation of the switch with a plurality of connections.

19. The device to control transmittal of a signal between an input and an output of claim 15, wherein:
only signal paths carrying a Hot Plug Detect (HPD) signal are interrupted by actuation of the switch with a plurality of connections.

20. The device to control transmittal of a signal between an input and an output of claim 15, wherein:
only signal paths carrying video signals carried by pins 1 through 12 are interrupted by actuation of the switch with a plurality of connections.
